(19) United States
(12) Patent Application Publication
(10) Pub. No.: US 2007/0081543 A1
(43) Pub. Date: Apr. 12, 2007

(54) Network utilization control apparatus and method of using

(76) Inventors: Manrique Brenes, Corona Del Mar, CA (US); Matthew B. McRae, Laguna Beach, CA (US); Allen J. Huotari, Garden Grove, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/247,084

(22) Filed: Oct. 11, 2005

(51) Int. Cl. H04L 12/56; H04L 12/66

(52) U.S. Cl. 370/401; 370/463

(57) ABSTRACT

In accordance with an embodiment of the present invention, a Customer Premises Equipment (CPE) apparatus includes a first communications unit and a processing unit. The first communications unit sends and receives message packets over a wide area network (WAN), and the processing unit controls the sending and receiving of message packets through the first communications unit. The sending and receiving of message packets comprises network traffic, while each packet has a packet size corresponding to an amount of WAN network utilization for each packet. The processing unit is adapted to measure, report, and limit the amount of WAN network utilization.

### TECHNICAL FIELD

This invention relates generally to electronic communication over a network, and more particularly to measuring, reporting, and limiting network utilization.

### BACKGROUND

In many broadband markets, network access can be purchased based on the amount of data transferred, or utilization. For example, a service provider may charge $10 for every 100 Megabytes of user data transferred. Alternatively, some service providers may charge a flat rate for utilization up to a specified quota amount during a subscription period, and charge significantly more if the utilization exceeds the quota before the end of the period. Therefore, there remains a need in the art for devices and methods that address the problem of controlling costs associated with network access based on utilization.

### BRIEF DESCRIPTION OF THE DRAWINGS

FIG. 1 shows a portion of a hierarchical, switched-packet network, in accordance with an embodiment of the present invention.

FIG. 2 shows a traffic flow diagram that graphically represents an exemplary amount of network traffic flow through a Customer Premises Equipment (CPE) router that illustrates an exemplary amount of network utilization through each network connection, in accordance with an embodiment of the present invention.

FIG. 3 shows a table relating various network applications to various application-layer protocols, in accordance with an embodiment of the present invention.

FIG. 4 shows a block diagram of a CPE gateway/router, in accordance with an embodiment of the present invention.

FIG. 5 shows a traffic measuring flow diagram, in accordance with an embodiment of the present invention.

FIG. 6 shows a traffic reporting flow diagram, in accordance with an embodiment of the present invention.

FIG. 7 shows an exemplary, graphical utilization report, in accordance with an embodiment of the present invention.

FIG. 8 shows a traffic limiting flow diagram, in accordance with an embodiment of the present invention.

Embodiments of the present invention and their advantages are best understood by referring to the detailed description that follows. It should be appreciated that like reference numerals are used to identify like elements illustrated in the figures.

### DETAILED DESCRIPTION

Devices and methods are disclosed herein, in accordance with one or more embodiments of the present invention, that provide network utilization control for measuring, reporting, and limiting network traffic being sent or received over a network. The devices and methods may also be effective in controlling the cost of access to network services by intelligently limiting the flow of various types of network traffic under certain conditions.

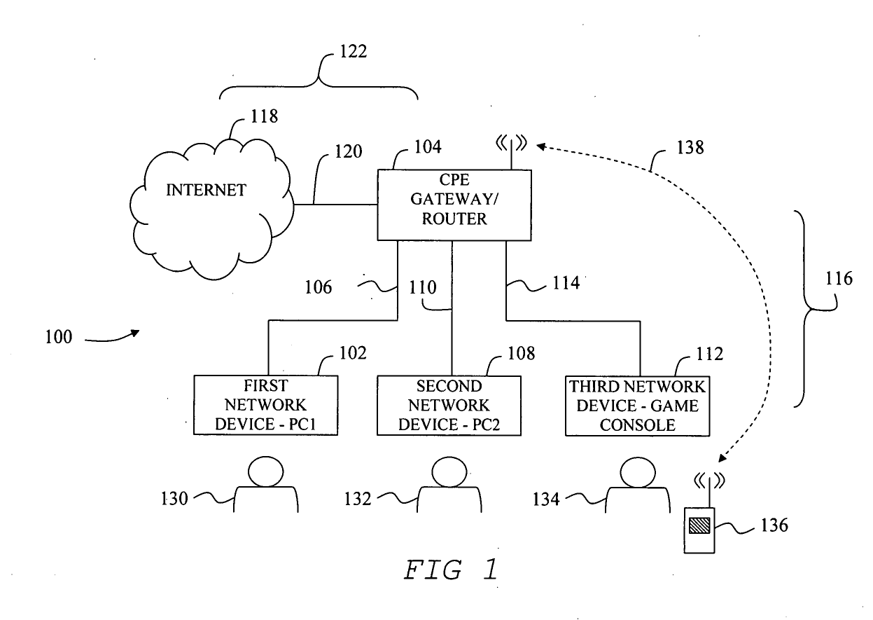

FIG. 1 shows a portion of a hierarchical, switched-packet network 100 where messages are divided into message packets and then sent individually from a source address to a destination address according to a Wide Area Network (WAN) protocol such as the ubiquitous Transfer Control Protocol/Internet Protocol (TCP/IP). A message can be any type of digital data including electronic mail (e-mail), a data file, a multimedia file such as streaming audio or video, and an instant message (IM). Once the message packets arrive at the destination address, they are reassembled into the original message. Message packets that are sent or received over a network are considered network traffic, and the amount of network traffic defines the network utilization, or simply network usage. By monitoring and restricting the amount of network traffic flowing on or between networks, the utilization may be known and controlled.

Network 100 includes a first network device 102, such as a first personal computer (PC1) 102, which can be connected to a CPE router/gateway device (or apparatus) 104 through a first communications channel 106. Similarly, a second network device 108, such as a second personal computer (PC2) 108, can be connected to CPE 104 through a second communications channel 110. Finally, a third network device 112, such as an internet-capable game console (GC) 112, can be connected to CPE 104 through a second communications channel 114. First network device 102, CPE router 104, second network device 108, and third network device 112 comprise the elements of an exemplary cluster with communication interconnections that comprise a local area network (LAN) 116 at a first level of hierarchy.

At a second level of hierarchy, CPE 104 connects to the Internet 118 via communications channel 120 so that all network traffic to and from LAN 116 passes through CPE 104 and communications channel 120. In this manner, CPE 104 can be connected to a wide area network (WAN) 122, also called a broadband connection, at a higher level of hierarchy with a wider scope, in contrast with LAN 116 that has a comparatively narrow scope. The connections to and from Internet 118 are shown in abstract since other elements may be included such as modems, other routers or gateway devices, dynamic host configuration protocol (DHCP) servers, or other network devices at other hierarchical levels.

A first user 130 may operate PC1 102 to gain access to Internet based services such as the sending or receiving of electronic mail (e-mail), accessing the World-Wide-Web (WWW), sending or receiving an instant message (IM), uploading or downloading a file using File Transfer Protocol (FTP), or exchanging data with other users in a peer-to-peer (P2P) network arrangement. Similarly, a second user 132 may operate PC2 108 and a third user 134 may operate GC 112 in order to gain access to the described Internet-based services. Third user 134 may also use a hand-held wireless network device 136, such as a Personal Digital Assistant (PDA), in order to access services through a wireless connection 138 to a Wireless Access Point (WAP) within CPE 104.

Each network device node (102, 104, 108, 112, and 136) operating on network 100 has an Internet Protocol (IP) address that is unique for the particular scope of the device within the network. That is, each node at the same level of hierarchy must have a unique network address to transfer data packets between the various nodes without conflicts. When crossing a level of hierarchy, a network address translator (NAT) may be employed to translate between WAN network addresses and LAN network addresses, for example. For the purposes of this disclosure, communication channels (106, 110, 114, 120, 138, and others) can include wired or wireless connections so that digital message information may be exchanged according to a communications protocol such as the Internet Protocol (EP) on a switched packet network.

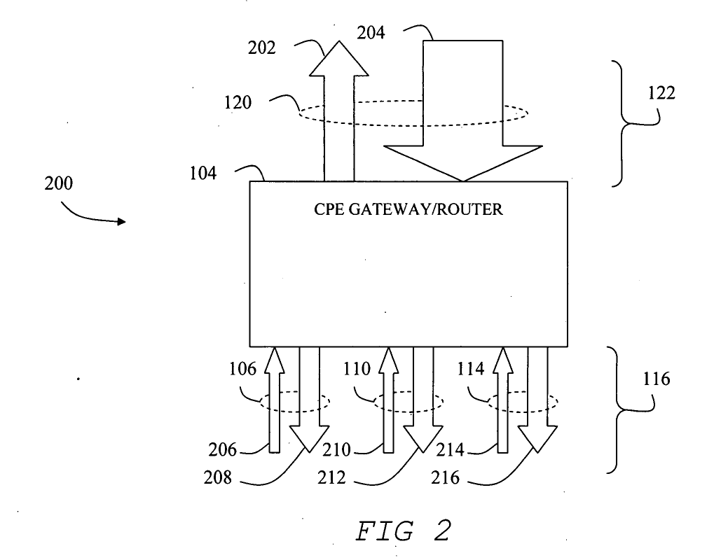

FIG. 2 shows a traffic flow diagram 200 that graphically represents an exemplary amount of network traffic flow through CPE router 104. CPE 104 operates as a gateway device since all network traffic flowing to and from LAN 116 must flow through CPE 104. Specifically, traffic flow diagram 200 graphically illustrates an exemplary amount of network utilization through each network connection (106, 110, 114, and 120). Network utilization is a measure of use, and can include past utilization, current utilization, and future utilization. Alternatively, the term bandwidth is often used to indicate network use or capacity. Past utilization means the amount of network traffic that has passed through the connection over a prior period of time. Current utilization reflects the instantaneous, or nearly instantaneous flow of network traffic at a particular moment of time or recent window of time. Future utilization means the amount of network traffic that is likely to occur in the future based on the past and current network utilization.

As described above, network connection 120 carries all network traffic to and from CPE 104 on WAN 122 and includes upstream (or upload) traffic 202 and downstream (or download) traffic 204. Upstream traffic 202 includes all message packets sent from CPE 104 onto WAN 122 in a direction from LAN 116 to WAN 122, while downstream traffic 204 includes all message packets received by CPE 104 from WAN 122 in a direction from WAN 122 to LAN 116. Using CPE 104 as the reference point, message packets sent from CPE 104 onto WAN 122 can be considered WAN upstream packets or upstream WAN traffic, while message packets received by CPE 104 from WAN 122 can be considered WAN downstream packets or downstream WAN traffic. These directions are arbitrary directional annotations, and the same packet traveling on the same communications channel may be considered upstream traffic or downstream traffic depending on the network device used as a reference point. Depending on the protocol, the upstream utilization may be typically larger than, smaller than, or equal to the downstream utilization. Typically, data transferred according to a WWW protocol will have a larger downstream utilization since a user operating a web-browser on a personal computer will typically enter a request for data, comprising very few message packets, followed by a response to the request that may include very many message packets, typically comprising a graphics-rich web-page that is then delivered to the user's web-browser application. Conversely, a web-server network device (not shown) will typically have the opposite utilization profile for the same protocol.

Similar to the description of network traffic on WAN 122, network traffic on LAN 116 includes traffic on communications channel 106 comprising upstream traffic 206 and downstream traffic 208. Traffic on communications channel 110 includes upstream traffic 210 and downstream traffic 212. Finally, traffic on communications channel 114 includes upstream traffic 214 and downstream traffic 216. The upstream and downstream directions may be inherited based on convention or based on the highest-flow communications channel for a particular network device. Assuming CPE 104 does not restrict the flow of any message packets, all received message packets will pass through CPE 104 and emerge as sent message packets. In this case, the LAN 116 utilization will be equal to the WAN utilization. Stated differently, the sum of the LAN 116 upstream network utilizations (206, 210, and 214) is equal to the WAN 122 upstream network utilization 202, and the sum of the LAN 116 downstream network utilizations (208, 212, and 216) is equal to the WAN 122 downstream utilization 204. However, if any packets are restricted, the utilizations will not be equal. In a practical system, some errors may cause a small number of packets to be erroneously sent or misrouted. Such error packets are not considered significant in this discussion.

A message packet typically has a defined format including a header portion and a payload portion. Each message packet has a packet size, or amount of data, comprising an amount of information being transported by the packet. This packet size can be measured in terms of bits (binary digits, one-by-one) or bytes (8-bits together). When a large number of packets are transferred over a communications channel, it is common to refer to the amount of data transferred, or network utilization, in terms of K-bytes (KB=2¹⁰ bytes), or even Mega-bytes (MB=2²⁰ bytes). The header portion typically includes a destination address, a sender address, a protocol identifier that indicates the packet-type and governs the format of the payload, and other data that can be used to ensure packet/data transfer integrity. The payload portion can include a segment of actual message data such as a portion of an e-mail message being sent or received. The header information and packet format are described in a document published by the Internet Engineering Task Force (IETF), titled Request For Comments (RFC) 791 (IETF-RFC791).

The product of the packet size and a number of packets sent or received comprises the amount of data moved over the network, also called the network utilization for that packet. A sequence of larger message packets, where each packet contains relatively more data in the payload portion, will require more network utilization, or time on the network, for the same number of packets sent or received at a given data transfer rate. Conversely, a sequence of smaller packets, where each packet contains relatively less data in the payload portion, will require less network utilization to transport. Network utilization may be measured based on various levels of abstraction. The highest level of abstraction includes measuring utilization based on the raw number of message packets, independent of the size of the individual message packets. An intermediate level of abstraction measures utilization based on a fixed packet size where the utilization is the product of the fixed packet size and the number of packets. Finally, the lowest level of abstraction measures utilization based on computing the actual size of each message packet to produce the highest degree of accuracy in terms of the actual amount of data flowing over the network. Stated differently, where the packet size is not uniform, utilization may be determined by computing the actual size of the message packets. Utilization may be measured over a certain period of time to provide an amount of utilization per unit time, such as MB per month, or KB per hour, etc.

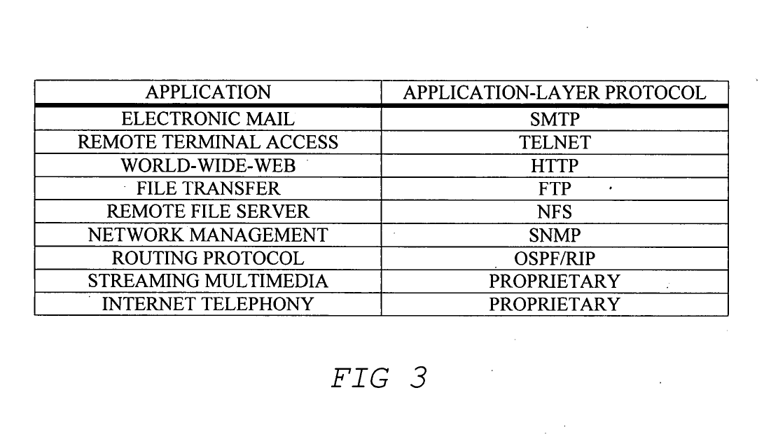

While the packet format remains similar, different types of data and different amounts of data may be transferred based on an application-layer protocol or other standard. Portions of the total network utilization can be measured based on different types of packets or different application-layer protocols. In reference to FIG. 3, various application-layer protocols are listed that are commonly used with different types of data transfers in various network applications. These application-layer protocols can be specified in the packet header information and may be used to classify the associated message packets into different types of message packets. For electronic mail, a Simple Mail Transfer Protocol (SMTP) can be used. For remote terminal access, the TELNET can be used. For access to the World-Wide-Web (WWW), the HyperText Transfer Protocol (HTTP) can be used. For sending or receiving files, the File Transfer Protocol (FTP) can be used. For remote file server access, the Network File System (NFS) protocol can be used. For network management, the Simple Network Management Protocol (SNMP) can be used. For communicating information about which networks each router can reach and how far away those routers are, an Open Shortest Path First (OSPF) or Routing Information Protocol (RIP) protocol can be used. Finally, for streaming multimedia or internet telephony, proprietary protocols are often used. Some protocols, such as the File Transfer Protocol (FTP), typically include large data transfers requiring more network utilization. Other protocols, such as SMTP for e-mail, would typically require less network utilization. By measuring, reporting, and restricting data packets based on their packet types, network utilization can be effectively managed.

Many service providers (SPs) charge their users (subscribers) based on a periodic utilization quota, or on a per MB basis. When a periodic utilization quota is included in a service agreement, some service providers may charge significant additional fees when the quota is exceeded. Thus, a user would benefit by using a router or gateway device that could measure utilization and control traffic being sent over the broadband connection in order to control network access costs. According to one embodiment, a router or gateway measures (counts up) the number of bytes (or other increment) of traffic being sent and received over its WAN port and reports the measurement result. The upload and download traffic could be measured separately or summed to provide a total network utilization amount. These numbers are important because some SPs only track download traffic while other SPs track all traffic sent or received over the broadband connection.

Once the utilization information is gathered through measuring, it can be presented or reported in various ways including a graphical or textual representation on a web-browser, electronic mail, and instant message formats in order to notify a user or other interested party such as a network systems administrator. Depending on the urgency of the reporting event as defined by the reporting actions, the generated report may be specified as immediate, periodic, or stored. An immediate report is generated right away and reported to the user through a rapid notification means including generating an e-mail, sending an instant message, or causing the generation of a flag or pop-up notification on a monitor, for example. A periodic report may be generated periodically based on the expiration of a predetermined time period and reported to the user through a less urgent notification process. Finally, an archive report may be generated and then stored away for retrieval at some later time on a non-urgent basis. A utilization report may be present in various formats, including:
Web Browser (WWW): The router could present this information to an end user as represented on a graphical user interface (GUI), typically a web page viewed on a computer monitor. A user or administrator could access the web page directly from a LAN device by entering 192.168.1.1 into an address field of a web-browser application running on the LAN device, for example. A text and/or graphical representation of utilization could then be examined by viewing the browser. In one example, the report may include basic exemplary utilization information such as an Upload amount of 1,547 KB, a download amount of 54,872 KB, and a total utilization of 56,419 KB. Alternatively, this type of information in the utilization report may also be provided in a graphical format.
Electronic mail (E-mail): A user could configure the router/gateway to send an e-mail to one or more e-mail addresses where the e-mail includes a report of utilization. This report could be generated on-demand basis or based on a periodic reporting schedule that would allow regular tracking of the utilization. The user could define the frequency of the notification by specifying a reporting rule based on a time period, such as a day, week, month. In yet another alternative, the user could specify a utilization increment as a reporting rule, such as “report utilization every 100 KB”, for example.
Short Message Service (SMS): The user could configure the router/gateway to use SMS, Instant Message (IM), Text Message (TM), or some other instant communications protocol or service to immediately notify the user or administrator of the utilization information. Such a notification may require additional capabilities provided by another network device such as an instant message server (not shown).

The router could have the option for the user to include multiple conditions, such as the allowed traffic quota, percentage used in the current period, and a time period. For example, if the user is allocated 100 MB of broadband utilization every thirty days, this information can be incorporated in a measuring and reporting process. Further, a user could specify a threshold percentage or raw amount of utilization as a trigger for a reporting or a limiting event. For example, the user could specify a reporting action when the traffic approaches 90% of the utilization quota. In the above example of an allocation of 100 MB, the user would be notified when 90MB had been used. A notification can be specified based on the upload amount, download amount, or total amount in any combination. For example, a Boolean combination of reporting rules may be established that specify notification when the current total utilization amount is X % AND the upload amount is Y % of the total allocation. Detection of these conditions may indicate the download requests are high, possibly leading to an overflow of the download quota resulting in increased costs to the user.

When the above described system is implemented in a router or gateway device, the end user is capable of tracking and restricting network traffic in order to control costs. The restriction can be selective as well, being based on the type of application or service being used. This method could take advantage of a firewall incorporated in some routers or gateways. In one example, the router could separately measure the different types of packets by protocol and application instead of only the total packets. In this manner, CPE 104 can both display more detailed information to a user, and potentially limit certain types of traffic to control network access costs.

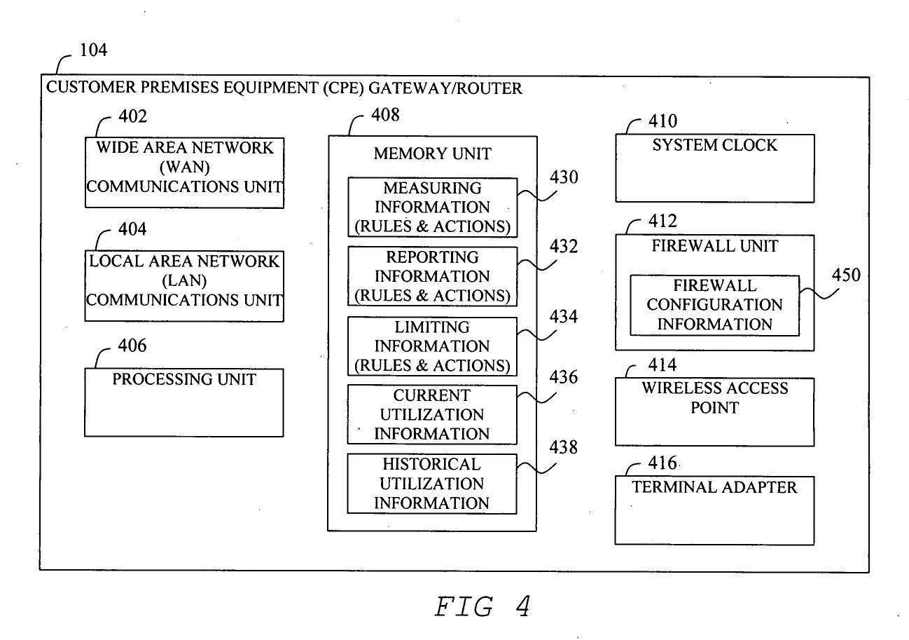

FIG. 4 shows a block diagram of a Customer Premises Equipment (CPE) 104 gateway/router in accordance with an embodiment of the present invention. In reference to FIGS. 1 and 4, CPE 104 includes a wide area network (WAN) communications unit 402 for sending and receiving message packets over WAN 122, a local area network (LAN) communications unit 404 for sending and receiving message packets over LAN 116, a processing unit 406 for storing, retrieving, and manipulating data within CPE 104 and for controlling the sending and receiving of messages through WAN communications unit 402 and the LAN communications unit 404. CPE 104 also includes a memory unit 408 for storing and retrieving information, a system clock 410 for providing a time reference, a firewall unit 412 for selectively preventing the passage of unwanted traffic, a wireless access point 414 for enabling wireless connections on LAN 116, and a terminal adapter 416 for interfacing with a non-network device user terminal such as a standard telephone, for use in Voice over Internet Protocol (VoIP) services.

Processing unit 406 can be a suitably programmed microprocessor or microcomputer. Memory unit 408 stores and retrieves information under the control of processing unit 406. Memory unit 408 can include any device that is enabled to store and retrieve information including information related to network utilization such as measuring information 430, reporting information 432, limiting information 434, current utilization information 436, and historical utilization information 438. Memory unit 408 can be implemented as any combination of information storage and retrieval systems including a random access memory (RAM), a read only memory (ROM), a magnetic recording and reproducing device, an electrically alterable storage and retrieval device such as an electrically erasable programmable ROM (EEPROM), a mass data storage system, or a register file implemented with discrete components.

Measuring information 430 can include measuring rules and actions, where the measuring rules define specifically what network traffic is measured and under what conditions, while the measuring actions define how the traffic is measured. For example, some service providers only charge based on download utilization, so download utilization may be measured while upload utilization may not be measured. A measuring information rule could limit measurement to only download utilization, or to message packets received by CPE 104 from WAN 122. Alternatively, some types of network traffic may be measured as both upload utilization and download utilization, such as peer-to-peer (P2P) access, while other network traffic may be measured as only download utilization or only upload utilization. In yet another alternative, a measurement rule including no conditions may be implemented so that all traffic is measured through a specified network connection. Any combination of rules to measure network traffic may be implemented based on the quantity and type of traffic utilization consumed, including a pre-defined utilization quota, a certain message packet type or priority, a certain application-layer protocol, a packet direction, a particular network device or device type, a specific user account, or a network device address.

The time of the traffic flow, including a designation as peak usage time or an off-peak usage time, may be used in a measuring rule in order to measure traffic having these or other attributes. Because network congestion may be higher during some portions of a given period (mornings, evenings, weekends) a service provider may wish to charge a premium for utilization during these peak usage times in order to encourage users to utilize bandwidth during off-peak time. A service provider may wish to charge more per MB for particular types of network traffic flow during peak usage time, such as FTP or P2P traffic that may typically require larger bandwidth. Another measure of network utilization can be termed Quality of Service (QoS), which can reflect both priority and reliability of a particular connection or session. A connection with a high QoS may have a lower average network delay or a higher guaranteed average data transfer rate when compared with lower priority or lower reliability connections. In this manner, measuring actions can correspond to one or more measuring rules based on the quantity, quality, and time of the traffic flow. Hence, two clients who consume the same quantity of network utilization (e.g. 1 MB) may be charged differently depending on these other factors.

Similar to the measuring information 430, reporting information 432 can include reporting rules and actions where the reporting rules define specifically what network traffic is reported, while the reporting actions specify how the utilization is reported. For example, the traffic reporting information rules may include a threshold utilization amount that is some percentage of a predetermined utilization quota, while the traffic reporting information actions may specify a reporting action that will take place when the corresponding threshold is exceeded. Reporting the utilization can take many forms, as discussed in reference to the notification formats above. Reporting actions correspond to one or more reporting rules. A calendar application running on processing unit 406 may utilize system clock 410 to define the reporting period(s) and expiration, where multiple, overlapping reports may be generated under program direction.

Limiting information 434 can include limiting rules and actions where the limiting rules define acceptable or unacceptable network utilization, while the limiting actions specify how the network utilization is limited. Essentially, the limit actions correspond to where the current network utilization falls within the limit rules framework. For example, limiting information 434 can include an upload and download traffic quota, an overall traffic quota, and an individual quota for each of the various types of upload and download traffic. In one application, if limiting information 434 includes an overall utilization quota, and the actual utilization reaches a predetermined percentage of that utilization quota, then a limit action can be implemented that will block passage of predetermined types of network traffic in order to avoid exceeding the overall utilization quota. In this manner, a user may shape the utilization of different types of message packets based on a percentage of each application or protocol utilization quota for a predetermined period. Specifically, a limiting rule could disable FTP download traffic when the overall utilization amount is 90% of quota, or higher. In another example, measuring rules may indicate all traffic is measured, a reporting rule may specify reporting when utilization exceeds 80% of quota, while a limiting rule may specify limiting certain types of network traffic when utilization exceeds 95% of quota. In view of the above measuring, reporting, and limiting information, CPE 104 may selectively measure, report, and limit network traffic in order to monitor and control utilization.

Firewall unit 412 examines received packets and determines whether the packets should be allowed to proceed through CPE 104 based on stored firewall configuration information 450. A particular type of firewall, a Stateful Packet Inspection (SPI) may be used that analyzes packets in terms of a current transaction session, where all incoming connections are examined to determine if they are a legitimate or valid reply to a previous request from within the network. In this manner, the firewall can assume incoming packets are valid or legitimate because the connection itself is legitimate. Alternatively, all packets may be inspected to determine if they are a legitimate or valid reply. Returning to filtering packets based on valid connections, if the packets are deemed to be valid based on the current session, the valid packets are allowed to pass through the firewall. However, if the packets are not deemed valid, the invalid packets are blocked by the firewall. Processing unit 406 may use the capabilities of firewall unit 412 to limit packet transmission in order to carry out one or more limiting actions triggered by a limiting rule.

Some embodiments of CPE 104 may include Wireless Access Point (WAP) 414 and/or Terminal Adapter (TA) 416. Wireless access point (WAP) 414 provides wireless network access on LAN 116 for one or more wireless devices, such as hand-held wireless network device 136, a wireless laptop computer (not shown), or a wireless VoIP telephone (not shown). Terminal adapter 416 can be implemented as a part of CPE 104 or can be a stand-alone network device (not shown) having a data connection to CPE 104. When embodied as a telephone adapter, terminal adapter 416 can convert analog telephone signals to digital packets in a broadcasting mode and converts digital packets to analog telephone signals in a receiving mode in order to provide network access for an otherwise non-accessible service terminal (not shown). Various types of terminal adapters may be used to interface with other user devices. TA 416 may be used to interface with other non-network devices (not shown) such as a camera or a video monitor.

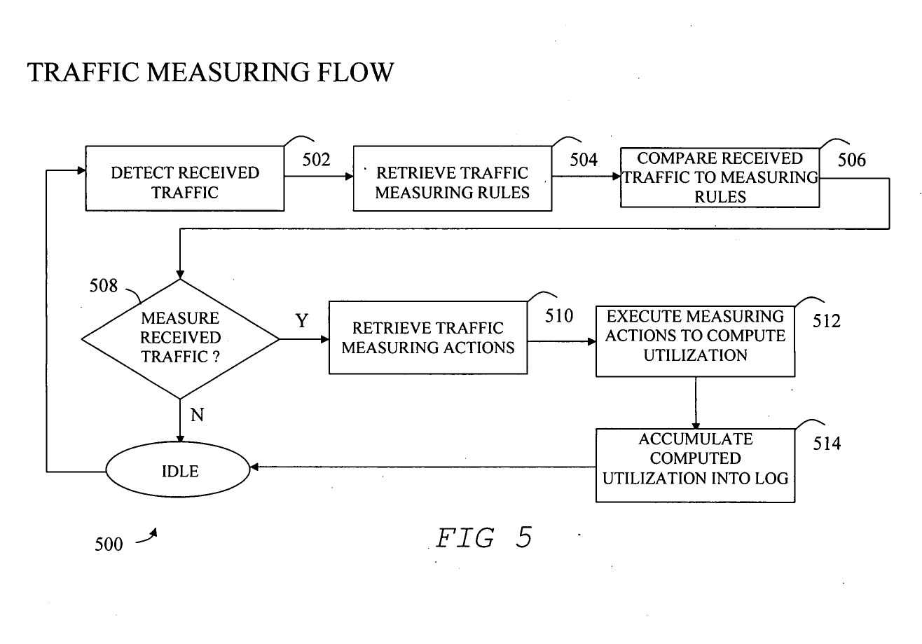

FIG. 5 shows a traffic measuring flow diagram 500, in accordance with an embodiment of the present invention. Flow 500 includes various operations involved with measuring the flow of network traffic into and out of CPE 104, and begins with detecting received traffic in operation 502, which can include detecting the receipt of a message packet. In reference to FIGS. 4 and 5, once the message packet is received, flow 500 continues in operation 504 with retrieving the traffic measuring rules from the traffic measuring information 430 stored in memory unit 408, and control moves to operation 506 where the received traffic is compared with the retrieved measuring rules. After comparing the retrieved measuring rules with the received traffic, control moves to operation 508 where processing unit 406 determines whether the received traffic measuring rules indicate the received traffic will be measured. If the measuring rules indicate measurement is not required, measuring flow 500 stops by returning to an idle state awaiting the next received traffic. However, in operation 508, if the traffic measuring rules indicate measurement is required, control moves to operation 510 where the traffic measuring actions of the traffic measuring information 430 are retrieved. Once the traffic measuring actions are retrieved, control moves to operation 512 where the traffic measuring actions are executed. Once all the measuring actions are executed, flow 500 stops by returning to an idle state awaiting the next received traffic.

Because flow 500 relates to the measurement of traffic, the traffic measuring actions describe how to compute the network utilization. For example, a traffic measuring action may be to count up only the number of received packets. Alternatively, another traffic measuring action may be to multiply the number of received message packets with the size of each packet to determine the actual number of bits or bytes that were transferred with the received traffic. Once the traffic utilization amount is computed in operation 512, control moves to operation 514 where the result of the network utilization computation is accumulated into an appropriate utilization log, after which the traffic measuring flow returns to an idle state awaiting the detection of received traffic.

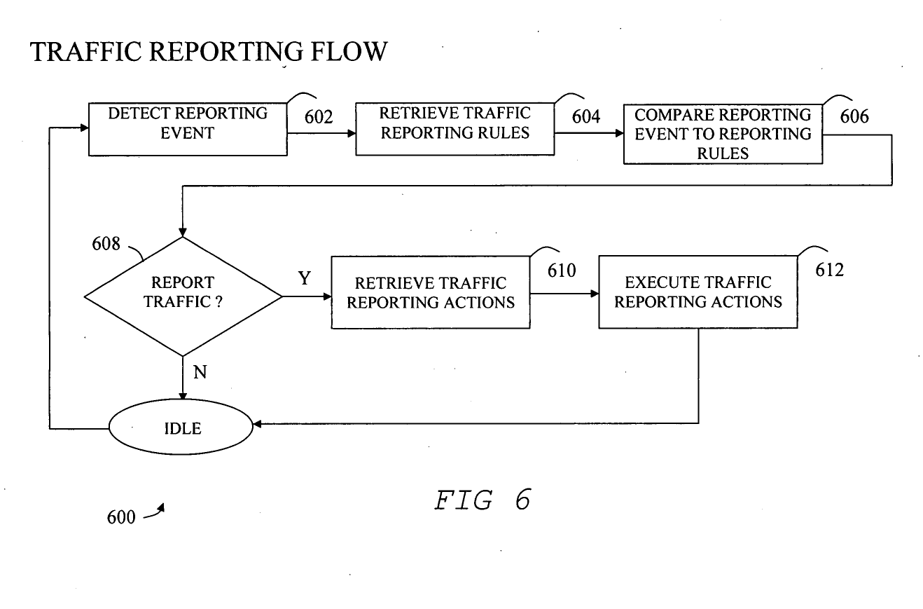

FIG. 6 shows a traffic reporting flow diagram 600, in accordance with an embodiment of the present invention. Flow 600 includes various operations involved with reporting the flow of traffic into and out of CPE 104 based on the reporting events including detection of received traffic, expiration of a reporting time period or epoch, or receipt of an on-demand reporting request from a user, systems administrator, or another network device. Flow 600 begins with detection of a reporting event in operation 602. A reporting event can occur under many conditions. First, a reporting event may be caused by various occurrences including the receipt of network traffic. It may be desirable to detect the receipt of a certain type of, possibly unexpected or non-allowed, network traffic right away. For example, if FTP uploads are not allowed from any user on LAN 116, then a report may be needed immediately following an attempted FTP upload attempt. Second, a reporting event may occur based on established reporting periods so that reports of network utilization are generated periodically. This reporting period can be, for example, every day, every week, or every month. Synchronization to one or more service provider schedules may be required in order to accurately reflect the current charges for a current billing cycle. For example, the VoIP service provider may have an established schedule that repeats based on the 15th day of every month, and a periodic report could be requested based on this reporting window. Other reporting windows may be overlaid so that the network utilization of different services or user accounts may be periodically reported.

As discussed above, the reporting epoch may be generated based on the system clock 410, as shown in FIG. 4. An on-demand reporting request may be received from a user or systems administrator requesting the current utilization information, previous utilization information, or predicted future utilization information for a particular service, in the current reporting period based on the current utilization levels. For example, if the current utilization for a particular service is running at an average rate of 10 MB per day and twelve days remain in the current reporting period, then a estimated additional utilization amount of 120 MB may be added to the current actual utilization amount to determine a utilization forecast, with the assumption that the utilization pattern will not change throughout the end of the reporting period. If the utilization forecast exceeds the expected quota, such a forecast could allow a user or administrator to take action to avoid exceeding the quota, or to plan for the additional costs.

In reference to FIGS. 4 and 6, once the reporting event is detected in operation 602, control moves to operation 604 where processing unit 406 retrieves the traffic reporting rules from traffic reporting information 432 from memory unit 408. Once the traffic reporting rules are retrieved, flow 600 continues with comparing the reporting event to the retrieved reporting rules in operation 606. After comparing the retrieved reporting rules with the reporting event, control moves to operation 608 where processing unit 406 determines whether the received reporting rules indicate traffic should be reported. If the reporting rules indicate traffic is not to be reported, reporting flow 600 stops by returning to an idle state awaiting the next reporting event. However, in operation 608, if the traffic reporting rules indicate traffic is to be reported, control moves to operation 610 where the traffic reporting actions of reporting information 432 are retrieved. Once the traffic reporting actions are retrieved, control moves to operation 612 where the traffic reporting actions are executed. Once all the reporting actions are executed, flow 600 stops by returning to an idle state awaiting the next reporting event.

Reporting actions can include generating a report for storage in a report log, or generating an e-mail to a user or systems administrator indicating the current or past utilization information, for example. Alternatively, another traffic reporting action may be to copy the current utilization information 426 to historical utilization information 438 in order to preserve the utilization information for a given period. For example, current utilization information 436 may be copied to an archive file located on a mass data storage system (not shown) in order to archive the utilization information. A user could set the router to report when a particular type of traffic exceeds a predetermined threshold, such as when the e-mail traffic exceeds 1 MB. This threshold can be different for each different type of network traffic as discussed in reference to FIG. 3. This allows the user to shape the percentage of traffic each application or protocol can use in a given time period. This limitation may be desirable so that a different type of network traffic, such as P2P traffic, does not consume too much of the bandwidth allocation, to avoid the condition where a user might not access e-mail to avoid paying significantly higher costs for the additional access.

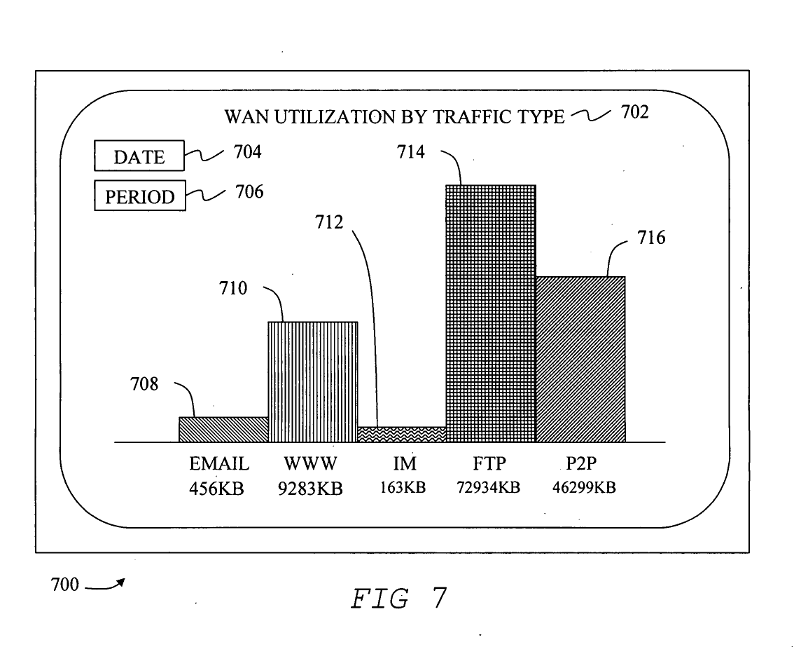

FIG. 7 shows an exemplary, graphical utilization report 700, in accordance with an embodiment of the present invention. The source data comprising report 700 could be reconstructed from current utilization information 436 or historical utilization information 438, for example. Report 700 could be displayed on a Graphical User Interface (GUI) such as a computer monitor (not shown) through a web-browser application running on PC1 102. In this example, various types of network traffic are shown and labeled with a title 702, a date 704, and a reporting period 706. Since report 700 may include historical or current information, the label information (702-706) may be necessary to distinguish from other, similar reports. Exemplary report 700 includes a bar-graph style representation of relative network utilization by traffic type measured in KB, including electronic mail (E-mail) traffic 708 comprising utilization of 456 KB for the reported period, WWW traffic 710 comprising utilization of 9283 KB, Instant Message (IM) traffic 712 comprising utilization of 163 KB, File Transfer Protocol (FTP) traffic 714 comprising utilization of 72934 KB, and Peer-to-Peer (P2P) traffic 716 comprising utilization of 46299 KB (FIG. 7 is not to scale). Report 700 is an example where CPE 104 measures and reports on many different types of traffic.

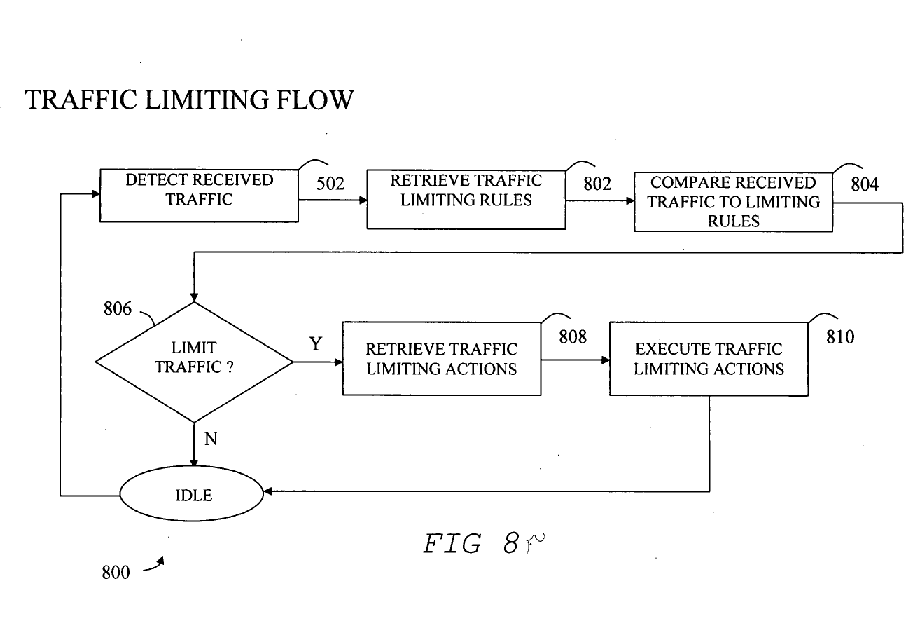

FIG. 8 shows a traffic limiting flow diagram 800, in accordance with an embodiment of the present invention. Flow 800 includes various operations involved with limiting the flow of network traffic into and out of CPE 104. Flow 800 begins with detecting received traffic in operation 502, which can include detecting the receipt of a message packet. In reference to FIGS. 4 and 8, once the message packet is received, flow 800 continues with retrieving the traffic limiting rules of the limiting information 434 from memory unit 408 in operation 802, and control moves to operation 804 where the received traffic is compared with the retrieved limiting rules. After comparing the retrieved limiting rules with the received traffic, control moves to operation 806 where processing unit 406 determines whether the received traffic limiting rules indicate the received traffic will be limited. If the limiting rules indicate limiting traffic is not required, flow 800 stops by returning to an idle state awaiting the next received traffic. However, in operation 806, if the traffic limiting rules indicate limiting is required, control moves to operation 808 where the traffic limiting actions of the traffic limiting information 434 are retrieved. Once the traffic limiting actions are retrieved, control moves to operation 810 where the traffic limiting actions are executed. Because flow 800 relates to the limiting of message traffic, the traffic limiting actions describe how to block or allow network traffic. Once all the limiting actions are executed, flow 800 stops by returning to an idle state awaiting the next received traffic.

In a further example, a traffic limiting action may be to block all network traffic of a particular type. Alternatively, another traffic limiting action may be to allow network traffic of a particular type to a particular user or communications channel on LAN 116. For example, a user could restrict P2P traffic to no more than 50 MB per month to ensure the P2P service account does not go over an established quota. Further, a systems administrator could restrict e-mail traffic to no more than 10 MB per user to ensure a user account is not used to forward SPAM e-mails. Finally, the router/gateway could monitor, report, and restrict traffic by user or device. This would let the end user set quotas for individual people or devices on LAN 116. For example, the user could restrict PC1 102 to only 10 MB of P2P access per month, or limit any user of gaming console 112 to only 20 MB per month. Once all traffic limiting actions specified in operation 810 are completed, traffic limiting flow 800 returns to an idle state awaiting the detection of subsequently received traffic. Although there can be interaction between the measuring, reporting, and limiting operations, flows 500, 600, and 800 are essentially separate loops that can operate concurrently.

Although the invention has been described with respect to particular embodiments, this description is only an example of the invention's application and should not be taken as a limitation. Consequently, the scope of the invention is set forth in the following claims.

We claim:

1. A customer premises equipment (CPE) apparatus, comprising:
a first communications unit adapted to send and receive message packets over a wide area network (WAN), the sending and receiving of message packets comprising network traffic; and
a processing unit adapted to control the sending and receiving of message packets through the first communications unit, each message packet having a packet size corresponding to an amount of WAN network utilization for each packet, the processing unit being adapted to one of measure, report, and limit the amount of WAN network utilization.

2. The CPE apparatus of claim 1, wherein each message packet is of a predetermined type and the processing unit is adapted to one of measure, report, and limit the amount of network utilization based on the predetermined message packet type.

3. The CPE apparatus of claim 1, further comprising:
a memory unit adapted to store and retrieve one of measuring information, reporting information, limiting information, and network utilization information.

4. The CPE apparatus of claim 3, wherein the processing unit measures the network utilization based on the measuring information, the measuring information including at least one measuring rule and at least one measuring action.

5. The CPE apparatus of claim 4, wherein the measuring information includes a measuring rule based on one of a no conditions, a predetermined utilization quota, a predetermined packet type, a predetermined application-layer protocol, a predetermined packet direction, a predetermined user account identity, a predetermined network device type, and a predetermined network device address.

6. The CPE apparatus of claim 4, wherein the measuring information includes a measuring action that includes one of a computation of network utilization in terms of one of a packet number, a packet size, and an accumulated utilization amount.

7. The CPE apparatus of claim 3, wherein the processing unit reports the network utilization based on the reporting information, the reporting information including at least one reporting rule and at least one reporting action.

8. The CPE apparatus of claim 7, wherein the reporting information includes a reporting rule based on one of a predetermined utilization quota, a predetermined packet type, a predetermined application-layer protocol, a predetermined packet direction, a predetermined user account identity, a predetermined network device type, and a predetermined network device address.

9. The CPE apparatus of claim 7, wherein the reporting rule based on the utilization quota is based on a current utilization amount in comparison with a predetermined percentage of the utilization quota.

10. The CPE apparatus of claim 9, wherein the reporting information includes a reporting action that includes one of generating one of an immediate report, a periodic report, and an archive report, the immediate report being generated independent of a user request, the periodic report being generated based on the expiration of a predetermined time period, and the archive report being generated and stored into memory for access at a later time based on a user request.

11. The CPE apparatus of claim 3, wherein the processing unit limits the network utilization based on predetermined limiting information, the limiting information including at least one limiting rule and at least one limiting action.

12. The CPE apparatus of claim 1, further comprising:
a second communications unit adapted to send and receive message packets over a local area network (LAN), the processing unit being adapted to control the sending and receiving of message packets through the second communications unit, the processing unit being adapted to one of measure, report, and limit the amount of LAN network utilization.

13. A customer premises equipment (CPE) apparatus, comprising:
means for sending and receiving message packets over a wide area network (WAN);
means for sending and receiving message packets over a local area network (LAN), the sending and receiving of message packets comprising network traffic;
means for controlling the sending and receiving of message packets over the WAN and LAN, each sent and received message packet having a packet size comprising an amount of network utilization; and
means for at least one of measuring, reporting, and limiting the amount of network utilization.

14. The CPE apparatus of claim 13, further comprising:
means for storing and retrieving at least one of measuring information, reporting information, limiting information, and network utilization information, the means for measuring the network utilization being based on measuring information including at least one measuring rule and at least one measuring action, the means for reporting the network utilization being based on reporting information including at least one reporting rule and at least one reporting action, the means for limiting the network utilization being based on limiting information including at least one limiting rule and at least one limiting action.

15. A method of operating a customer premises equipment (CPE) apparatus, the method comprising:
detecting receipt of a message packet from a network;
comparing the received message packet to the network utilization measuring rule; and
executing a measuring action if the measuring rule is satisfied.

16. A method of operating a customer premises equipment (CPE) apparatus, the method comprising:
detecting a reporting event;
comparing the reporting event to a network utilization reporting rule; and
executing a reporting action if the reporting rule is satisfied.

17. A method of operating a customer premises equipment (CPE) apparatus, the method comprising:
detecting receipt of a message packet from a network;
comparing the received message packet to a network utilization limiting rule; and
executing a limiting action if the limiting rule is satisfied.

18. A method of operating a customer premises equipment (CPE) apparatus, the method comprising:
measuring past network utilization based on a predetermined quota to produce a current network utilization measurement; and
limiting future network utilization based on the current network utilization measurement.

19. The method of claim 18, wherein limiting future network utilization includes the operation of:
shaping the utilization of different types of message packets based on a percentage of each application or protocol utilization quota for a predetermined period.
